(19) United States
(12) Patent Application Publication
(10) Pub. No.: US 2008/0085160 A1
(43) Pub. Date: Apr. 10, 2008

(54) SOIL SUBSTITUTE MATERIALS AND METHODS OF USING THE SAME

(76) Inventor: JAMES W. TAYLOR, Newburgh, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/867,677

(22) Filed: Oct. 4, 2007

Related U.S. Application Data
(60) Provisional application No. 60/828,182, filed on Oct. 4, 2006.

(51) Int. Cl. B09B 3/00; E01C 3/04

(52) U.S. Cl. 405/129.2; 404/31; 404/75; 405/129.95

(57) ABSTRACT

A soil substitute material is configured with ground construction and demolition (C&D) waste materials suitable for use in grading or construction projects in industrial, commercial, and after conducting specific preparation steps is useful in selective residential settings, road and highway grading, backfill and cap materials at environmental sites, alternative daily cover at landfills, rough grading for roadbeds and constructing athletic fields, and landfill construction and operation as a stabilized and compactable construction material.

### CROSS REFERENCE TO RELATED APPLICATIONS

This application is related to and claims priority from U.S. Provisional Ser. No. 60/828,182, filed Oct. 4, 2006, the entire contents of which are herein incorporated by reference.

### BACKGROUND OF THE INVENTION

1. Field of the Invention

The invention relates to soil substitute materials used in various construction operations. In particular, the invention relates to a method of processing construction and demolition debris (C&D) and use of the processed C&D debris and other precursor materials as soil substitute materials in general, and in landfill construction operations specifically.

2. Related Art

Americans generate trash at a high rate of about four pounds per day per person, which translates to 600,000 tons per day or 210 million tons per year. About 27 percent of the solid trash is recycled or composted, 16 percent is burned and 57 percent is buried in landfills. A licensed and fully permitted operational “landfill” is a complex designed structure built into or on top of the ground in which trash is isolated from the surrounding environment (groundwater, air, rain).

A typical landfill 10 strata is illustrated in FIG. 1. A bottom or geomembrane sub-base layer 12 is usually made of natural earth clay grade material minimizing the movement of the upper layers relative to one another, serving to protect the intermediary layer of the landfill and in select circumstances supports a leachate pipe collection system configured to evacuate leachate from landfill 12. Such mechanical leachate pipe collections systems are able to transport leachate from a source to a later collection and study location.

An intermediary layer, geomembrane, 14 is used to provide an impermeable barrier for the trash and subsequent leachate or contaminated liquid and, thus, prevents contact between the trash/leachate and groundwater. Typically, geomembrane 14 is configured from durable, puncture-resistant synthetic plastic, such as polyethylene, high-density polyethylene(HDPE), polyvinylchloride (PVC), etc. and is capable of preventing the trash from coming into contact with the outside soil or native soil support base layer 12, and particularly any groundwater nearby.

A top layer 16 in addition to serving cushioning and filtering functions, also serves as a protective layer preventing geomembrane 14 from being punctured. In some conventional circumstances, the top layer 16 is commonly operative to support a gas collection pipe system (not shown) evacuating a gaseous medium (such as Methane etc.) which is produced by the decaying waste. Typically, top layer 16 is configured of natural sand/soil mined from another location and trucked to the use location.

Typical landfill 10 further includes a pipe-based leachate collection system (not shown, but well known to one of ordinary skill in the landfill arts) including pipes that run throughout landfill 10 and carry leachate to a leachate collection pond. Furthermore, bacteria within landfill 10 organically reduce (break-down/consume) the trash in the absence of oxygen (anaerobic typically) because the landfill is substantially airtight. A byproduct of this anaerobic breakdown is landfill gas, which contains approximately 50 percent methane and 50 percent carbon dioxide with small amounts of nitrogen and oxygen. This presents a hazard because the methane can explode and/or burn and, therefore, must be removed. To do this, a combination of pipes (again not shown, but well known to an artisan) are embedded in top layer 16 to collect the gas.

Perhaps, the most precious commodity and overriding problem in a landfill is air space. The amount of space is directly related to the capacity and usable life of the landfill. To increase the air space, trash is compacted into areas—cells—that contain only one day's trash 18. The trash 18 must be covered by a daily cover 20, which is, typically, several inches thick and is mined native sand and soil. Daily cover 20 provides an important service to the cleanliness of the region surrounding the landfill and acts as also as a cushion for vehicles traveling and compacting trash 18 between layers.

The daily cover, top layer and membrane sub-base layer 20, 16 and 12, respectively, like any mined sand/soil-based cover, are expensive to acquire, transport and lay down, and each cost from about $20 to $30 per cubic yard delivered (the geomembrane is commonly a sheet sold as the square meter, foot, or yard). Selected materials, such as geomembrane sub-base materials underlying the geomembrane, cost substantially more due to their importance in landfill liability and extensive mine-processing activities. Considering that a landfill typically occupies a large area (many acres), daily expenses associated with constructing and operating the landfill are enormous and to date there has been little possibility to reduce costs, and with landfills often supported by the taxpayer through local government taxes, little need to reduce costs. It is therefore a goal of the present invention to lower such costs by utilizing new relatively inexpensive sand/soil substitute material.

The search for alternative materials that meet the standards of various federal, state, and local agencies is not, of course, limited to the landfill daily operation. For example, with the continuing escalation of global fuel prices, road construction and other civil engineering projects are beginning to experience unprecedented construction cost increases. During 2005 and early 2006, some construction material prices rose much faster than consumer or producer prices indices. For example, the availability and cost of cement, gypsum, and other sand-related materials (serving as one of the main components of the roadbed structure) became a major concern of the road construction industry. Yet, soil-alternate materials capable of replacing the currently used native-sand/soil materials are not available and when the same are mined from selected locations remain materially expansive to the construction process.

The concept of waste reuse and/or recycling is not new. However, construction and demolition (C&D) debris accounting for almost 22 percent of the waste stream are underutilized, and many of these materials (plastics and metals for example) can be reused by a re-melting process, thus, prolonging supply of natural resources and potentially saving money in the process. Common C&D debris include, among others, stumps, drywall, lumber, drywall, metals, masonry (brick, concrete, etc.), carpet, plastic, pipe, rocks, batteries, contaminated dirt, paper, paint, cardboard, asphalt and soils or green waste (stump, trunks, and tree limbs) related to land development. Of these, metals are the most commonly recycled material while the rest makes up the majority of debris that still goes to a landfill as waste.

### SUMMARY OF THE INVENTION

In view of the above, it is proposed therefore that a need, therefore, exists for a method that improves the efficient use of resources associated with typical construction and demolition (C&D) debris.

It is also proposed therefore that another need exists for soil substitute materials that can be used in non-agricultural and construction applications as a bulking agents for dredge remedial projects.

It is also proposed therefore that another need exists for a method that minimizes both the operating expanses of landfill and road construction operations.

Still another need exists for a method of producing grading material from C&D debris that can be used in general and landfill construction operations.

Another need exists for a method of producing a sub-base geomembrane support, which underlies the geomembrane of the landfill, and an alternate daily cover (ADC) for landfill cells by utilizing a composite of processed C&D debris.

Yet another need exists for a new structure of landfill provided with the sub-base geomembrane and daily cover that are formed from a composite of processed C&D debris.

A further need exists for a method of forming a road base, foundation fill, casting fill, bulking agents including a composite of processed C&D debris.

These needs are satisfied by the present invention. Conceptually, the present invention allows for reusing of construction and demolition (C&D) debris, which are typically deposited in landfills as waste, in general and landfill construction operations as soil/sand substitute material.

In accordance with the inventive method, waste materials are received from a waste stream and further sorted out to segregate non-C&D debris wastes. Following the segregating operation, those C&D materials which can be recycled into specific industry products are removed. The remaining C&D materials are then ground to about a 3″ maximum particle size. In the end, the ground C&D materials are used as soil-alternative materials in a variety of industrial applications.

In accordance with one aspect of the inventive method, the ground C&D materials are manufactured and prepared and thereafter usable in various locals, including on the bottom of a landfill. Consequently, the C&D materials processed in accordance with the invention method are used as soil alternative grading materials to configure a geomembrane sub-base (AGM) replacing a traditional base soil layer.

In accordance with another aspect of the invention, the ground C&D materials are placed atop a cell of a landfill. As a result, the C&D materials are used as an alternative daily cover (ADC) replacing a traditional sand/soil cover.

The construction and demolition debris may be aged and cured in selected locations after being collected and in some-cases additionally pre-processed. Thereafter the then-cured debris may be processed by various equipment including, but not limited to, a tub grinder or other size-reducing and size-modifying equipment such as a ball mills and grinders, and further aged in windrows, long exposed pilings of material able to be approached for testing, temperature tracking, and turning as needed for curing. The resultant product is a soil like-material subsequently utilized as the sub-base geomembrane layer and/or a closure. Due to the inventive process, the ground C&D debris are a structurally sound, compactable material free from sharp angular products and substantively reactive surfaces (oxidizing/reducing). On site compaction testing revealed that the material obtained as a result of the inventive method can be significantly compacted up to a 50% volume reduction and can therefore withstand great weights/load masses without disturbance after compaction. The resultant material is also odor free and can be handled and stockpiled and otherwise transported with no adverse environmental effects.

Based on the extended experimentation to confirm the removal of likely leachate and reactive materials, and preparation the resultant material is highly resistant to further erosion and, thus, does not require additional erosion control or stabilization measures. As a consequence of the physical properties of the resultant material including, but not limited to, a relatively high surface friction coefficient, an area treated with the inventive material is reliably stabilized avoiding, thus, the need for other temporary stabilization steps. The proposed soil substitute C&D material produced by the inventive method consists of small-sized particles. If the material is produced by a single grinding operation, the particles each preferably have an outer diameter (OD) of about 2-3″. The “single ground” or “single grind” material (SGM) maybe be further subjected to a second grinding (“second grind” or additional grinding as necessary to achieve a desired particle size distribution). The second grinding produces about a 1″ maximum particle size. For obvious reasons, the double ground (DGM) material is more uniform than the single graded material and often visually resembles ordinary bark mulch and native earth. Use-approval for the single and double ground inventive materials have been and are being processed by a variety of federal and state agencies including, for example, New State Department of Environmental Conservation (NYSDEC) for use as landfill alternative cover (ADC) as viable soil-alternative materials.

The proposed inventive material is extremely practical. The cost of the delivered cubic-yard of the inventive material does not exceed $12 and is therefore extremely cost effective. The use of this material avoids the purchase of natural earth products (minimizing environmental impact) and translates into substantially reduced landfill closure costs, preservation of natural soils, and a new outlet for legal disposal of C&D debris.

### BRIEF DESCRIPTION OF THE DRAWINGS

The above and other features and advantages will become more readily apparent from the detailed description of the invention in conjunction with the following drawings, in which:

FIG. 1 is a cross sectional view of landfill configured in accordance with the conventional art.

FIG. 2A is a cross-sectional view of landfill configured in accordance with one aspect of the present invention.

FIG. 2B is a cross-sectional view of road structure configured in accordance with the present invention.

FIG. 3 is a flow chart illustrating one aspect of the inventive method noting a single grinding steps, although additional grinding steps may be conducted as will be discussed.

FIG. 4 is a particle distribution graph of soil substitute material commonly obtained by the inventive method.

FIG. 5 is a plain top view of a windrow on a supporting ground surface.

FIG. 6 illustrates the compactness properties of the inventive soil substitute material.

FIGS. 7 and 8 describe the results of respective total organic carbon and levels of selected metals in test leachate samples over time following the treatment and preparation methods discussed herein.

### DETAILED DESCRIPTION

Reference will now be made in detail to the invention that is illustrated in the accompanying drawings. Wherever possible, same or similar reference numerals are used in the drawings and the description to refer to the same or like parts or steps. The drawings are in simplified form and are not to precise scale.

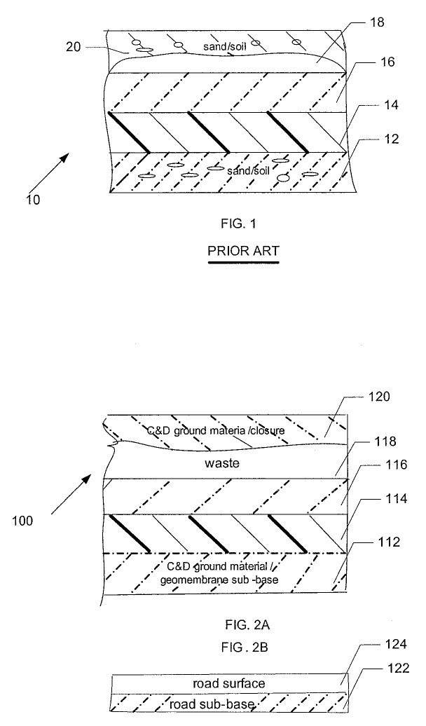

FIG. 2A illustrates the inventive structure of a landfill 100 that, by contrast to the related art in FIG. 1, is configured with at least one layer of soil substitute material comprising prepared construction and demolition (C&D) debris instead of conventional mined sand/soil materials. The inventive structure of landfill 100 has a conventional geomembrane 114 made of polymeric material and configured to line landfill sites to prevent passage of contaminants in the landfill site through to the ground water. Generally geomembranes are of PVC or high-density polyethylene (HDPE) or other polyolefin. Atop geomembrane 114 is a top layer 116 typically including gravel or sand/soil and optionally and configured to provide cushioning for the mass of waste which is piled atop layer 118. The top layer 116 is also configured to minimize puncturing geomembrane 114 by sharp debris.

Typically, geomembrane layer 114 is co-lined with a membrane sub-base layer 112 having several important functions. One of the functions of geomembrane sub-base layer 112 is to minimize displacement of the layers of landfill 100 relative to one another. Another function is to provide reliable packing for perforated pipes collecting water and leachate percolating through landfill 100. Still a further function of membrane sub-layer 112 is to cushion the mass of the upper structure of landfill 100.

In accordance with an aspect of the invention, sub-base geomembrane layer 112 includes prepared C&D materials. The C&D materials are ground into small particles each having an outer diameter (OD) which ranges between about 0.75″ and 3″ and more preferably have a tighter particle size distribution, as will be noted herein. The inventive sub-base geomembrane layer 112 is a replacement material to mined native soil, and is compactable material free from sharp angular objects capable of puncturing geomembrane 114.

The landfill 100, like any typical landfill, is divided into a plurality of cells B relatively small segments of the landfill configured to selectively receive daily waste. Upon being filled with daily waste 118, each cell must be closed. As a consequence, according to a further aspect of the invention, the inventive C&D materials form a closure 120.

While only closure and geomembrane sub-base layers 120 and 112, respectively, have been discussed to include the inventive C&D material, other layers, such as top layer 116, may also be formed from the inventive C&D material instead of typical mined sand/soil materials. As mentioned above, the cost of a one cubic yard of sand is about $20 B $30. Therefore, use of the present proposed materials throughout the landfill should reduce costs. Presently it is additionally proposed, that upon suitable preparation according to the proposed method herein, C&D materials may replace even the native mined soil employed for environmental sealing and growing of grass and trees atop a closed landfill.

In sharp contrast, the cubic yard of the inventive C&D material used for the landfill layers would cost, it is proposed, at most $12. Considering high construction costs of a landfill, would reduce the overall cost of the landfill construction, prevent mining to prepare use of native sand and soil, and provide an overall environmental benefit. In addition to the cost savings, the inventive landfill layers have other economical benefits. For example, the use of the C&D materials meets long standing federal policies promoting recycling and beneficial use of otherwise underutilized byproducts, which may be supported by particular legislative tax-based incentive programs. Also, as the extensive experiments show, the C&D materials used to configure soil-substitute layers in the landfill stand up well to significant rainfall showing no signs of erosion unlike conventional native mined soil and sand. Finally, the inventive C&D landfill layers are well stabilized avoiding the need for other temporary stabilization required when native (high-organic containing) soils are employed.

The use of the inventive layer is not limited to the landfill construction, as disclosed above, but can be applied to general construction operations as well. For example, FIG. 2B illustrates a simplified cross-sectional view of road. A road base 122 is configured of the inventive ground C&D materials and, thus, replaces the typical road base including sand and soil. The C&D debris initially cover the ground and are then compacted to support a road surface layer 124.

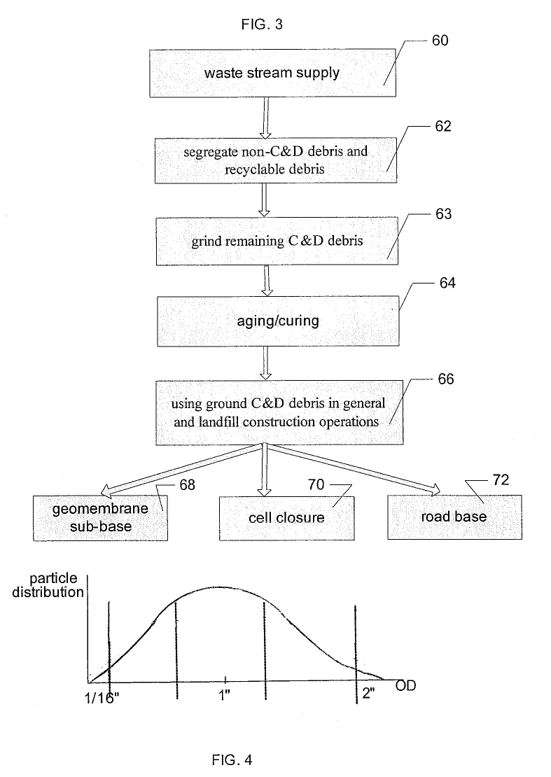

Referring to FIG. 3, the inventive method of producing ground C&D materials includes a step 60 during which C&D debris are accepted from waste stream and/or crushed at a demolition cite. The accepted debris are further inspected and sorted to segregate non-C&D debris wastes and materials which cannot be recycled, such as hazardous materials, or can be directly recycled into specific industry products, as shown by a step 62. The remaining materials which include, but are not limited to, drywall, wood, asphalt, concrete, paper, and stone, are ground to soil-like mass of particles each having an about 3″ maximum outer diameter, as indicated by a step 63. It is additionally preferred to remove the drywall so as to reduce the generation of hydrogen sulfide during curing providing a more uniform and stable product for application.

Referring to FIG. 4 in addition to FIGS. 2A, 2B and 3, a particle distribution curve complying with the desired bell- or dome-shaped structure indicates that the ground particles of the inventive C&D material each have a substantially spherical form. As a result, the inventive C&D material possess excellent packing properties which are important, for example, in a landfill construction in which geomembrane sub-base 112 (FIG. 2) not only stabilizes and protects geomembrane 112, but it also supports a leachate drainage system. The top layer 116, if formed from the inventive C&D material, also may benefit from the substantially spherical shape of particles by providing reliable packing for a gas-collection and evacuation pipe system.

The physical properties of the inventive ground material are also beneficial to the road construction industry. Referring to FIG. 2B, the inventive C&D material used for forming road sub-base 122 is adequately dense which is important because it determines the ultimate allowable load which will be permissible during use by vehicles and for qualification as a structural fill. The density of the inventive material is further important because it influences the permeability, stiffness and strength of the fill, thus affecting the settlement and ultimate stability of the road structure.

The outer diameter of particles varies upon initial receipt and prior to processing, thereafter particles are reduced in overall size and are more similarly shaped (round-like) removing substantial long and pointing ends. The particles constituting the single ground C&D material each have an outer diameter varying between about an 1.15″ and 2″, whereas the double ground C&D material has particles whose outer diameter ranges from about 1/16th to 1.15″, as illustrated by FIG. 4. Advantageously, the particles of the single ground material each have the outer diameter of about 2″, and the outer diameter of each particle of the double ground material is about 1″. The grinding operation or step may be performed by a tub grinder, but other mechanisms for mechanical size-reduction well known to one of ordinary skill in the art may be used as well. It is worth mentioning that many of C&D materials include small particles that can be immediately screened without being ground. These additionally screened particles may be returned to the debris during curing and aging as will be discussed.

Returning to FIG. 3, the ground C&D material is further aged and cured, as indicated by a step 64, typically in windrows although other shapes and geometries maybe employed. The goal of the aging/curing step is to minimize organic content of the ground material, shrink any film-plastic and paper material to the point of not being objectionable for marketing, and produce a product resembling soil in terms of visual, chemical composition and physical and reactive properties. It is noted, that inspection and quality control in terms of temperature monitoring (to be discussed), chemical testing, and reactive analysis maybe repeated performed in the grinding and aging/curing steps, as will be discussed without departing from the scope of the present invention.

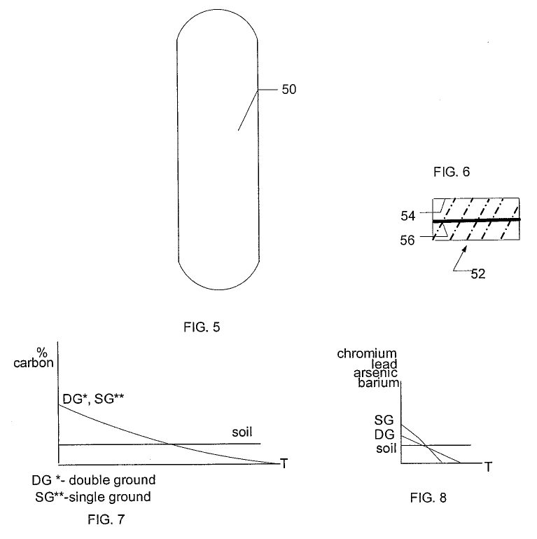

Referring to FIG. 5 in addition to FIG. 3, one of possible methods that can realize the aging and curing step may include collecting the ground material in specifically created windrows 50 having exposed and reactive side walls. The windrow size varies over time to control the curing process which proceeds along the same lines as organic wood curing for mulch production. Initially, window 50 is kept relatively tall, with exposed side walls and easy air flow to encourage the development of heat. As the pile temperature increases and works to reduce the organic content of the pile, windrow 50 is being monitored on a periodic basis, such as every day or any other interval, along with moisture content, pH, chemical content, etc.

The monitoring of the aging material includes temperature measurements as well as photo cataloguing. Windrowing will cease when windrow 50 is unable to create heat under reaction, and the material takes on the visual characteristics of soil. At the conclusion, a portion of the cured material may be screened and randomly tested to determine if any unwanted materials remain in the final cured product. The duration of aging/curing step 64 depends upon a variety of factors including, but not limited to, the windrow configuration, materials to be cured, climatic conditions and many others. As a result, the aging/curing step may last as short as several hours and as long as several months. The temperature range also can vary within about a 30 □-60 □ range. Typically, a plurality of windrows is created each being, for example, about 13 to 20 feet deep, about 275 feet long and about 35 feet wide. Thus, in the disclosed example, the basal area of each windrow is about 4,000 to 5,000 cubic yards of material.

If desired, the cured C&D material may be subjected to a second grinding or multiple grindings, and of course multiple quality control testing until reaching a testing result comparable to the native mined sand or soil it replaces. Observation allows an ordinary skilled worker to differentiate between the inventive single ground (SG) and double ground (DG) materials based on size. The DG material is more uniform in its consistency, resembling ordinary bark mulch due to its' dark color. However, both the DG and SG (or subsequent ground) materials are well suited for general construction purposes as shown by step 66 of FIG. 3 and particularly advantageous for constructing an alternative geomembrane sub-base, alternative daily cover (ADC) and a road sub-base, as disclosed above and indicated by respective steps 68, 70 and 72. The inventive process of manufacturing C&D material as disclosed in reference to FIG. 3 is being considered by the New York State Department of Environmental Conservation (NYSDEC), and it should be recognized, that the size results from grinding may be readily maintained by additional screening and segregation steps as necessary.

The inventive soil substitute material has the chemical and physical properties in many respects exceeding the properties of soil and suitable for use in grading or construction projects in industrial, commercial, and certain residential settings which may include, but not limited to, road and highway grading, backfill and cap materials at brownfields and other environmental sites, rough grading in the construction of athletic fields or other landscaping projects, and grading needs. For example, the inventive material possesses the superb compactive and construction properties. FIG. 6 illustrates a substantially rectangular area 52, which, for example, is about 25 feet wide and 50 feet long. The area 52 is graded to an initial level 54 with the inventive material and further compacted using, for example, a Hanum model 3412 sheep's-foot vibratory roller.

Between successive applications of compactive effort, the density of the compacted material can be determined using a Troxler nuclear density gauge. As can be seen in FIG. 6, the material is capable of being compacted to a lower level 56, which is about 50% lower than an initial level 54. The maximum density of the final compacted material in the example disclosed above may vary from about 1670 lbs/cubic yard to about 1675 lbs/cubic yard and higher compactions may be achieved up to 1800 lb/cubic yard through extensive efforts employing the presently proposed method.

The analytical results of the initial and final analyses (total metals, total matrix sulfur, and synthetic precipitation leaching procedure meet and in many instances exceed all applicable standards established by local and federal jurisdictions. Both the inventive SG and DG soil substitute materials have been found pesticides free. Results of total matrix sulfur analyses range between about 1.5% and about 2.5%. Referring to FIG. 7, it has been found that in the inventive material total organic carbon levels are rapidly reduced below the level usually associated with soil. Similarly, FIG. 8 illustrates that concentration of, for example, chromium, lead, arsenic and barium rapidly decreases to the level substantially lower than the concentration levels of these metals in soil.

Thus, the inventive single ground (SG) and double ground (DG) soil substitute materials including construction and demolition debris provide long-term minimization of migration of liquids through the closed landfill; function with minimal maintenance; promote drainage and minimize erosion or abrasion of the final cover; accommodate settling and subsidence to maintain integrity of the daily and final cover; have a permeability less than or equal to the permeability of a bottom liner system or natural sub-soils; meet EPA and State of New York standards and cost considerably less than soil materials.

While the invention has been described in conjunction with specific embodiments, it is to be understood that many alternatives, modifications and variations will be apparent to those skilled in the art in light of the foregoing description.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of using construction and demolition (C&D) material comprising: grinding the C&D material; and
applying the ground C&D material to one of general and landfill construction operations as soil-alternative material.

2. The method as previously characterized in claim 1, wherein the applying of the ground C&D material comprises forming a sub-base membrane in the landfill construction operation.

3. The method as previously characterized in claim 1, wherein the applying of the ground C&D material comprises forming a daily cover in the landfill construction operation.

4. The method as previously characterized in claim 1, wherein the applying of the ground C&D material comprises forming a road sub-base.

5. The method as previously characterized in claim 1, further comprising accepting the C&D material from waste streams and segregating the accepted C&D material from recyclable and reusable materials;

6. The method as previously characterized in claim 1, wherein the segregated C&D material comprises unusable drywall, wood, asphalt, concrete, paper, stone or a combination thereof.

7. The method as previously characterized in claim 1, wherein the step of grinding includes forming a plurality of particles each having a maximum outer diameter of about 3″ and a minimum outer diameter of about 0.75″.

8. The method as previously characterized in claim 7, wherein the step of grinding further includes a single grinding operation to form a single ground C&D material, the particles of the single ground material each having the outer diameter not exceeding about 2″.

9. The method as previously characterized in claim 7, wherein the single ground C&D material is further grinded to form a double ground material, the particles of the double ground material each having the outer diameter not exceeding about 1″.

10. The method as previously characterized in claim 1, further comprising aging the segregated C&D material for a period of time ranging between about several hours to about several months and simultaneously therewith, curing the aging C&D material at temperature generated by the aging C&D material.

11. The method as previously characterized in claim 10, further including at least one of a step of compacting the segregated C&D material optionally during and after the aging of said material and applying a moisture to the segregated C& D material during the aging of the material.

12. The method as previously characterized in claim 11, wherein compacting is effected until the C7D material has a density of between about 1670 lbs/cu.ft to about 1800 lbs./cu.ft.

13. The method as previously characterized in claim 12, wherein compacting is effected until the C7D material has a density of between about 1670 lbs/cu.ft to about 1675 lbs./cu.ft.

14. A soil substitute material comprising ground construction and demolition (C&D) waste materials, wherein the C&D material is suitable for use in grading and construction projects in industrial, commercial, and selective residential settings, road and highway grading, backfill and cap materials at environmental sites, rough grading for constructing athletic fields, and landfill construction and operation.

15. The soil substitute material as previously characterized in claim 14, wherein the C&D material is compactable material free from sharp angular products.

16. The soil substitute material as previously characterized in claim 14, wherein the C&D material comprises a plurality of particles each having a substantially spherical shape and an outer diameter ranging between about 0.75″ and about 3″.

17. The soil substitute material as previously characterized in claim 16, wherein the outer diameter ranges between about 1″ and 2″.

18. The soil substitute material as previously characterized in claim 14, wherein the C&D material comprises at least one item selected from the group consisting of unusable drywall, wood, asphalt, concrete, paper, stone and a combination thereof.

19. The soil substitute material as previously characterized in claim 14, wherein the C&D material is configured as at least one of a geomembrane sub-base, a daily closure and top layer of a landfill, wherein the top layer is located between the geomembrane sub-base and daily closure.

20. The soil substitute material as previously characterized in claim 14, wherein the C&D material is configured as a road sub-base.

21. A construction site comprising a plurality of sequentially formed layers lying atop one another, at least one of the plurality of layers comprising a construction and demolition (C&D) soil substitute material.

22. The construction site as previously characterized in claim 21, wherein the construction site is a landfill, and the at least one layer comprising the C&D material is selected from one of a geomembrane sub-base material, a daily closure and a top layer underlying the daily closure.

23. The construction site as previously characterized in claim 21, wherein the construction site is a road construction setting, and the at least one layer comprising the C&D material being a road sub-base.

24. The construction site as previously characterized in claim 21, wherein the C&D material is a compactable material free from sharp angular products and comprises a plurality of particles each having a substantially spherical shape and an outer diameter ranging between about 0.75″ and about 3″, and the soil substitute material comprising unusable drywall, wood, asphalt, concrete, paper, stone or a combination thereof.
